(19) United States
(12) Patent Application Publication
(10) Pub. No.: US 2025/0164634 A1
(43) Pub. Date: May 22, 2025

(54) METHOD FOR OPERATING A MULTI-RANGE RADAR SYSTEM FOR A VEHICLE

(71) Applicant: VALEO SCHALTER UND SENSOREN GMBH, Bietigheim-Bissingen (DE)

(72) Inventors: Christian Sturm, Bietigheim-Bissingen (DE); Alexander Vanaev, Bietigheim-Bissingen (DE)

(73) Assignee: VALEO SCHALTER UND SENSOREN GMBH, Bietigheim-Bissingen (DE)

(21) Appl. No.: 18/832,509

(22) PCT Filed: Jan. 25, 2023
(86) PCT No.: PCT/EP2023/051743

§ 371 Date: Jul. 24, 2024

(30) Foreign Application Priority Data
Jan. 26, 2022 (DE) 10 2022 101 752.4

(51) Int. Cl. G01S 13/931

(52) U.S. Cl. CPC G01S 13/931; G01S 2013/93271

(57) ABSTRACT

A method for operating a radar system for a vehicle includes carrying out a radar measurement. The radar measurement includes using a transmitting antenna element of the radar system to transmit a radar signal and putting at least one receiving antenna element of the radar system on standby to receive radar echo signals based on the radar signal. The transmitting antenna element is actuated according to a control scheme. A basic control scheme for the radar system is specified according to the intended use of the radar system, and is adjusted based on a measurement node of the radar system. The basic control scheme is used to accommodate a basic main beam axis of the transmitting antenna arrangement to the intended use of the radar system.

### TECHNICAL FIELD

The invention relates to a method for operating a radar system for a vehicle, in which the radar system is used to carry out at least one radar measurement that involves using at least one transmitting antenna element of at least one transmitting antenna arrangement of the radar system to transmit at least one radar signal and putting at least one receiving antenna element of at least one receiving antenna arrangement of the radar system on standby to receive any radar echo signals based on the at least one radar signal, the at least one transmitting antenna element being actuated according to at least one control scheme.

The invention further relates to a radar system for a vehicle having at least one transmitting antenna arrangement that has at least one transmitting antenna element for transmitting radar signals, having at least one receiving antenna arrangement that has at least one receiving antenna element for receiving radar echo signals, and having at least one control and detection device for actuating at least the transmitting antenna elements and for detecting radar echo signals received by the at least one receiving antenna element, wherein the radar system has at least one adjustment means having at least one control scheme in order to adjust at least one main beam axis of the at least one transmitting antenna arrangement.

The invention additionally relates to a vehicle having at least one radar system.

### PRIOR ART

A radar system and a method for operating a radar system are known from DE 10 2019 134 304 A1. The radar system comprises a plurality of transmitting antennas by means of which radar signals can be transmitted to a monitoring region of the radar system, a plurality of receiving antennas by means of which echoes from radar signals reflected in the monitoring region can be received, and at least one antenna electronics unit to which the transmitting antennas and the receiving antennas are connected for signal transfer purposes via antenna supply lines. The radar signals can be radiated using a beamforming method and/or a beam steering method. In addition or as an alternative, it is possible to switch over between a beamforming mode with an increased range and a conventional MIMO mode with an increased angular resolution. The radar system and the method can be used in a vehicle, in particular a motor vehicle.

The invention is based on the object of designing a radar system, a method and a vehicle of the type mentioned in the introduction that allow the possibilities for using the radar system to be extended.

### DISCLOSURE OF THE INVENTION

The invention achieves the object for the method in that a basic control scheme for the radar system, which is specified according to the intended use of the radar system on the vehicle, is adjusted for at least one measurement mode of the radar system at the latest at the beginning of the at least one radar measurement, the basic control scheme being used to accommodate a basic main beam axis of the at least one transmitting antenna arrangement to the intended use of the radar system, and the at least one radar measurement being carried out starting from the basic control scheme.

As an alternative or in addition, the invention can achieve the object for the method in that the method is suitable for operating at least one radar system according to the invention.

According to the invention, a basic control scheme is specified on the basis of the intended use of the radar system on the vehicle. The intended use implies a mounting location and/or an alignment of the radar system on the vehicle. The basic control scheme is specified on the basis of the intended use so that the basic main beam axis of the at least one transmitting antenna arrangement is aligned in relation to at least one radar system reference region for at least one measurement mode of the radar system. In this way, one and the same radar system can be accommodated to different intended uses, in particular different mounting locations and/or different alignments, on the vehicle. Accommodation merely requires the basic control scheme to be changed. Accommodation can be carried out using software. In this way, it is not necessary to make changes to the hardware. The at least one radar measurement is carried out starting from the basic control scheme. Other control schemes, in particular control schemes based on a MIMO method and/or a beamforming method, can be “fitted” to the basic control scheme, as it were.

The basic control scheme is adjusted for at least one measurement mode of the radar system.

A measurement mode is a mode in which the radar system is at least temporarily operated. In particular, it may be a range measurement mode, in particular a short-range measurement mode or a long-range measurement mode.

In a beamforming method, the transmitting antenna elements are actuated by coherent transmission control signals that have defined phase shifts with respect to one another. The individual radar signals emitted by the individual transmitting antenna elements are superposed to form a joint radar signal. The superposition allows a beam angle of the joint radar signal and thus the field of view to be reduced compared with the fields of view of the individual radar signals. The energy of the individual radar signals can thus be combined and the range of the joint radar signal can be increased. A direction of the main beam axis of the joint radar signal can also be changed by appropriately changing the phase shifts. The main beam axis defines the propagation direction of the joint radar signal and thus the field of view.

In a MIMO method (multiple-in-multiple-out method), the individual radar signals of the individual transmitting antenna elements are encoded differently, and so the signal paths of the individual radar signals can be evaluated by the individual transmitting antenna elements independently of one another. It is thus possible to achieve a higher angular resolution compared with the beamforming method. Additional focusing of the transmission power is not carried out here, which results in a shorter range than in the case of the beamforming method.

The basic main beam axis is the axis of the at least one transmitting antenna arrangement from which further adjustments to the direction of the main beam axis can be made during a radar measurement. In particular, the basic main beam axis may be aligned such that in the case of a vehicle it points in the direction of travel or contrary to the direction of travel.

The radar system can be used in vehicles, in particular motor vehicles. The radar system can advantageously be used in land vehicles, in particular passenger vehicles, trucks, buses, motorcycles, or the like, aircraft, in particular drones, and/or watercraft. The radar system can also be used in vehicles that can be operated autonomously or at least semiautonomously.

The radar system may advantageously be connected to at least one electronic control device of a vehicle or machine, in particular a driver assistance system and/or a chassis control system and/or a driver information device and/or a parking assistance system and/or a gesture recognition system or the like, or may be part of such a device or system. In this way, at least some of the functions of the vehicle can be performed autonomously or semiautonomously.

The radar system can be used to detect stationary or moving objects, in particular vehicles, people, animals, plants, obstacles, uneven driving surfaces, in particular potholes or stones, roadway boundaries, road signs, free spaces, in particular parking spaces, precipitation or the like, and/or movements and/or gestures.

In one advantageous configuration of the method, at least two transmitting antenna elements of at least one transmitting antenna arrangement can be actuated using respective transmission control signals in order to emit respective mutually coherent individual radar signals that are superposed to form the at least one radar signal, wherein, in the basic control scheme for the radar system, a basic phase shift, which may also be zero, between the respective transmission control signals is specified for the at least two transmitting antenna elements. The phase shift between two coherent individual radar signals can be used to change, in particular pivot, the main beam axis of the superposed radar signal composed of the individual radar signals. The basic phase shift can be used to adjust the basic main beam axis.

In another advantageous configuration of the method, a phase shift, in particular a basic phase shift, between the respective transmission control signals can be adjusted by means of at least one phase shifter, and/or a phase shift that is linearly proportional to a distance between the at least two transmitting antenna elements can be adjusted. Phase shifts can be easily adjusted by means of phase shifters. Phase shifts that are linearly proportional to the distances between the at least two transmitting antenna elements permit constructive superpositioning of individual radar signals.

In another advantageous configuration of the method, at least one basic control scheme can be adjusted using at least one intended use variable that characterizes an intended use, wherein the at least one intended use variable can be specified in a control device for the radar system, in particular a control device of the radar system, at the latest when the radar system is mounted on the vehicle,
and/or
at least one basic control scheme can be adjusted in a control device for the radar system, in particular a control device of the radar system. In this way, the control device can be used to process the at least one basic control scheme further using software.

The basic control scheme can advantageously be stored in a storage medium of the control device. In this way, the basic control scheme can easily be made available to the control device.

In another advantageous configuration of the method, the basic control scheme can be used to accommodate the basic main beam axis to the intended use in a long-range measurement mode of the radar system,
and/or
the radar system can be operated in different range measurement modes, in particular a long-range measurement mode and a short-range measurement mode, in alternation or at at least partly overlapping times,
and/or
at least one of the transmitting antenna elements can be actuated in multiple different range measurement modes in order to transmit radar signals, and/or multiple receiving antenna elements of at least one receiving antenna arrangement can be put on standby to receive echo signals.

In a long-range measurement mode, it is particularly advantageous to specify the direction of the basic main beam axis since, in this measurement mode, the transmitted radar signals are combined at a smaller beam angle, and so the range is increased.

The radar system can be operated in different range measurement modes, in particular a long-range measurement mode and a short-range measurement mode.

In the short-range measurement mode, it is possible to detect objects close to the radar system, in particular at distances of up to 100 m, in particular up to approximately 80 m. This requires a shorter range of the radar signals than in the long-range measurement mode. The transmission energy can thus be distributed over a beam angle of appropriate size. In this way, a field of view of appropriate size can be produced in the short-range measurement mode.

In the long-range measurement mode, objects can be detected at a greater distance, in particular in the region of up to 200 m or more. This requires the energy of the radar signals to be combined in order to produce the appropriate range. Therefore, the beam angle and thus the field of view are smaller in the long-range measurement mode than in the short-range measurement mode.

The different range measurement modes can be produced successively or partly simultaneously. In this way, it is possible to detect objects both close to the radar system in a correspondingly wide field of view and at a greater distance in a correspondingly smaller field of view. Objects located in front of the vehicle in the direction of travel or behind the vehicle in the direction of travel can thus be identified at an early stage in the long-range measurement mode.

At least some of the transmitting antenna elements can be actuated in multiple different range measurement modes in order to transmit radar signals. In particular, some transmitting antenna elements can be used both in the long-range measurement mode and in the short-range measurement mode. In this way, the number of transmitting antenna elements required can be reduced.

Multiple receiving antenna elements of at least one receiving antenna arrangement can be put on standby to receive. The use of multiple receiving antenna elements allows determination of the direction of detected objects to be improved.

In another advantageous configuration of the method,
the radar system can be operated at least temporarily using a control scheme based on a beamforming method and/or at least temporarily using a control scheme based on a MIMO method,
and/or
the at least one transmitting antenna arrangement can be actuated at least temporarily in at least two transmitting antenna groups, wherein the transmitting antenna elements within one transmitting antenna group can be actuated together and the transmitting antenna groups can be actuated separately.

A beamforming method can be used to adjust, in particular change, a direction of the transmitted radar signals. A MIMO method can be used to distinguish between the radar signals of the different transmitting antenna elements at the receiver end.

The transmitting antenna elements in transmitting antenna groups can be actuated more easily, in particular together. The joint actuation of two transmitting antenna elements can be used to superpose the individual radar signals emitted thereby to form a joint radar signal. The transmission energy and the range for the joint radar signal can thus be increased.

Separate actuation of the transmitting antenna groups permits the respective radar signals to be encoded. It is thus possible to distinguish between the radar signals and the signal paths of the transmitting antenna groups at the receiver end. In this way, the ascertainment of directions of detected objects can be improved.

In another advantageous configuration of the method,
at least one respective corresponding basic control scheme can be specified for the use of the radar system as a front radar system, a corner radar system, a side radar system and/or a rear radar system,
and/or
the basic control scheme can be used to align the basic main beam axis of the at least one transmitting antenna arrangement relative to at least one vehicle reference region, in particular a vehicle longitudinal axis,
and/or
the basic control scheme can be used to align the basic main beam axis of the at least one transmitting antenna arrangement relative to at least one radar system reference region, in particular an antenna plane. In this way, the basic main beam axis can be adjusted in each case according to the respective basic control scheme such that it points in the direction of travel or contrary to the direction of travel of the vehicle, irrespective of the intended use of the radar system as a front radar system, a corner radar system, a side radar system or a rear radar system. It is thus possible to detect objects in front of or behind the vehicle in the direction of travel in the basic setting of the radar system that is dependent on the intended use.

The basic control scheme can advantageously be used to align the basic main beam axis with respect to at least one vehicle reference region, in particular a vehicle longitudinal axis. In this way, the radar system may always be adjusted, depending on the intended use, so that it may be aligned with a monitoring region of interest, in particular in front of the vehicle in the direction of travel or behind the vehicle in the direction of travel, irrespective of its own orientation and/or its mounting location on the vehicle.

As an alternative or in addition, the basic control scheme can be used to align the basic main beam axis relative to at least one radar system reference region. In this way, the basic control scheme can be specified before the radar system is mounted on the vehicle, in particular during manufacture of the radar system.

The at least one radar system reference range may be an imaginary axis and/or a plane in relation to the geometry of the radar system, in particular an antenna arrangement. The at least one radar system reference range may advantageously be an antenna plane in which the respective phase centers of at least some of the transmitting antenna elements and/or the receiving antenna elements are located.

In another advantageous configuration of the method, at least one radar measurement can involve ascertaining at least one direction variable, which characterizes at least one direction of at least one object that reflects the at least one transmitted radar signal relative to the radar system in at least one dimension, and/or ascertaining at least one distance variable, which characterizes at least one distance of at least one object that reflects the at least one transmitted radar signal relative to the radar system, and/or ascertaining at least one speed variable, which characterizes at least one speed of at least one object that reflects the at least one transmitted radar signal relative to the radar system. In this way, it is possible to determine object information in the form of directions and/or distances and/or speeds of objects relative to the radar system, that is to say relative to the vehicle as well. The object information obtained in this way can be transmitted to a driver assistance system of the vehicle. The driver assistance systems can be used to control driving functions of the vehicle on the basis of the object information.

In another advantageous configuration of the method, multiple transmitting antenna elements of an antenna arrangement can be actuated in order to transmit radar signals, and multiple receiving antenna elements of the antenna arrangement can be put on standby to receive echo signals, geometric folding of the geometric position of the transmitting antenna elements and the receiving antenna elements of the antenna arrangement being used to determine a corresponding virtual receiving antenna array. In this way, it is possible to implement a virtual receiving antenna array that has more virtual receiving antenna elements than the real antenna arrangement. As such, the performance of the radar system can be improved. Appropriate geometric arrangement of the transmitting antenna elements and the receiving antenna elements allows the corresponding virtual receiving antenna array to be adjusted. As such, in particular an angular resolution for the determination of direction can be improved.

Furthermore, the invention achieves the object for the radar system in that the at least one adjustment means has at least two basic control schemes for different adjustments of the at least one main beam axis in at least one measurement mode of the radar system and at least one intended use specification means for specifying one of the at least two basic control schemes on the basis of an intended use of the radar system in at least one measurement mode of the radar system.

As an alternative or in addition, the invention can achieve the object for the radar system in that the radar system has means for carrying out the method according to the invention.

According to the invention, the radar system has at least one adjustment means that can be used to adjust at least two basic control schemes on the basis of the intended use of the radar system. In this way, the same radar system can be adjusted for at least two intended uses that require different adjustments of the at least one main beam axis. The at least one intended use specification means can be used to specify the appropriate basic control scheme that matches the desired intended use.

In another advantageous embodiment, the at least one adjustment means and/or the at least two basic control schemes and/or the at least one intended use specification means may be implemented at least in part using software, in particular in the control and detection device. In this way, one and the same radar system can be accommodated to different intended uses, in particular for different mounting locations and/or different alignments, on the vehicle without changing the hardware.

In another advantageous embodiment, the at least one adjustment means may have a basic control scheme for the use of the radar system as a front radar system and/or at least one basic control scheme for the use of the radar system as a corner radar system and/or at least one basic control scheme for the use of the radar system as a side radar system and/or a basic control scheme for the use of the radar system as a rear radar system. In this way, the radar system can be easily accommodated to the applicable intended use.

The basic main beam axis can thus advantageously be aligned parallel to the vehicle longitudinal axis irrespective of the mounting location and the alignment of the radar system on the vehicle. It is thus possible, in particular in the long-range measurement mode, to use the radar system to monitor a monitoring region in front of the vehicle in the direction of travel and behind the vehicle in the direction of travel.

In another advantageous embodiment, the at least one transmitting antenna arrangement may have at least two transmitting antenna elements, at least two of the transmitting antenna elements being able to be actuated separately in order to transmit radar signals and/or at least two of the transmitting antenna elements being able to be actuated together in order to transmit radar signals.

The separate actuation of at least two transmitting antenna elements allows the radar system to be operated according to a MIMO method.

As an alternative or in addition, at least two transmitting antenna elements can be actuated together. In this way, the respective individual radar signals emitted by the transmitting antenna elements can be superposed to form a joint radar signal. The superposition allows the transmission energy and thus the range of the radar signals to be increased. Furthermore, changing the phase shift of the individual radar signals allows the main beam direction to be changed.

In another advantageous embodiment, the at least one transmitting antenna arrangement may have at least two transmitting antenna elements, at least two of the transmitting antenna elements being arranged in a transmitting antenna group, wherein the distances between phase centers of adjacent transmitting antenna elements of the same transmitting antenna group correspond to approximately half the wavelength of the emitted radar signals and the transmitting antenna elements of the same transmitting antenna group can be actuated together or separately in order to transmit radar signals. The arrangement of transmitting antenna elements in transmitting antenna groups allows actuation of the transmitting antenna elements to be simplified.

The distance between the phase centers of the transmitting antenna elements of the same transmitting antenna group of half the wavelength of the radar signals permits a beamforming method to be carried out. In the beamforming method, the transmitting antenna elements of the same transmitting antenna group can be actuated together.

Actuating the transmitting antenna elements separately permits a MIMO method to be carried out.

In another advantageous embodiment, at least three transmitting antenna elements may be arranged in at least two transmitting antenna groups, wherein the distances between phase centers of adjacent transmitting antenna groups are greater than half the wavelength of the transmitted radar signals and/or wherein the distances between phase centers of adjacent transmitting antenna groups are approximately an integer multiple of half the wavelength of the transmitted radar signals. In this way, it is possible to operate the radar system both using a beamforming method and using a MIMO method. Furthermore, the radar system can also be operated using a combination of a beamforming method and a MIMO method.

In another advantageous embodiment, the at least one transmitting antenna arrangement may be implemented as a phased array and/or the radar system may have at least one phase shifter in order to produce phase shifts between coherent transmission control signals in order to actuate the transmitting antenna elements. In a phased array, the transmitting antenna elements can be actuated together using coherent transmission control signals. In this case, it is possible to produce a phase shift between the transmission control signals for the transmitting antenna elements. A phase shifter can easily be used to produce a phase shift between the transmission control signals of the transmitting antenna elements.

In another advantageous embodiment, at least one intended use specification means may have at least one intended use variable, in particular a variable that characterizes a phase shift. The at least one intended use variable can be used to adjust an applicable basic control scheme that can be used to actuate the corresponding transmitting antenna elements.

The at least one intended use variable may advantageously be stored in an appropriate storage means, in particular a storage means of the control and detection device. In this way, the applicable at least one intended use variable can be accessed easily and quickly.

In another advantageous embodiment, the radar system may have at least one adjustment means having at least two range control schemes in order to produce different range measurement modes, in particular in order to produce a long-range measurement mode and/or a short-range measurement mode. In this way, the radar system can be put into the appropriate range measurement modes starting from the basic control scheme that is part of the intended use by means of the range control schemes using the at least one adjustment means. The range control scheme is fitted to the applicable basic control scheme, as it were. At least two range control schemes allow the radar system to be operated in at least two range measurement modes, in particular in a long-range measurement mode and a short-range measurement mode.

In another advantageous embodiment, the radar system may have at least one means for operating the radar system using a MIMO method, a beamforming method and/or a combined MIMO/beamforming method. In this way, the radar system can be operated using the appropriate methods, in particular on the basis of an operating situation of the vehicle, in particular on the basis of a driving situation of the vehicle.

The MIMO method, the beamforming method and the combined MIMO/beamforming method can be carried out by way of appropriate actuation, in particular group actuation, of the transmitting antenna elements according to an applicable control scheme.

The at least one means for operating the radar system using the MIMO method, the beamforming method and the combined MIMO/beamforming method may be implemented using software. In this way, it is not necessary to accommodate the hardware when changing the method.

In another advantageous embodiment, at least one receiving antenna arrangement may have at least three receiving antenna elements, the respective phase centers of which are each arranged on one of two parallel imaginary receiving antenna axes, wherein at least one phase center of a receiving antenna element is arranged on each receiving antenna axis,
and/or
at least one receiving antenna arrangement may have at least four receiving antenna elements, the respective phase centers of which are each arranged on one of three parallel imaginary receiving antennas, wherein at least one phase center of a receiving antenna element is arranged on each receiving antenna axis. In this way, it is possible to ascertain directions in which detected objects are located relative to the radar system in two dimensions, in particular in azimuth and elevation. The arrangement of the receiving antenna elements on three parallel axes permits a genuine resolution in the direction at right angles to the receiving antenna axes and an ability to separate two objects that are detected using the radar system.

In another advantageous embodiment,
a distance between adjacent imaginary receiving antenna axes may correspond to approximately the wavelength of the radar signals transmitted by the transmitting antenna elements
and/or
a distance in the direction of the receiving antenna axes between respective phase centers of two adjacent receiving antenna elements on different receiving antenna axes may correspond to approximately half the wavelength of the radar signals transmitted by the transmitting antenna elements
and/or
a distance in the direction of the receiving antenna axes between respective phase centers of two adjacent receiving antenna elements on different receiving antenna axes may correspond to approximately the wavelength of the radar signals transmitted by the transmitting antenna elements
and/or
a distance between phase centers of two adjacent receiving antenna elements on the same receiving antenna axis may correspond to an integer multiple of half the wavelength, in particular double or three-times half the wavelength, of the radar signals transmitted by the transmitting antenna elements. In this way, the radar system can be operated according to a MIMO method, according to a beamforming method and a combination of beamforming method and MIMO method. Appropriate specification of the geometric positions of the receiving antenna elements and the geometric positions of the transmitting antenna elements allows a virtual receiving antenna array to be generated by way of a geometric folding. The virtual receiving antenna array may have more virtual receiving antenna elements than the receiving antenna elements that are physically present. In this way, it is possible to improve the performance of the radar system.

In another advantageous embodiment,
the phase centers of at least two receiving antenna elements may lie on a first receiving antenna axis, and the perpendicular to the first receiving antenna axis through the phase center of at least one receiving antenna element may lie on an adjacent second receiving antenna axis outside of a region containing the at least two receiving antenna elements on the first receiving antenna axis,
and/or
the phase centers of at least two receiving antenna elements may lie on a first receiving antenna axis, and the perpendicular to the first receiving antenna axis through the phase center of at least one receiving antenna element may lie on an adjacent second receiving antenna axis outside of a region containing the at least two receiving antenna elements on the first receiving antenna axis, and the perpendicular to the first receiving antenna axis through the phase center of at least one receiving antenna element may lie on a third receiving antenna axis outside of the region containing the receiving antenna elements on the first receiving antenna axis, said third receiving antenna axis being located opposite the second receiving antenna axis with respect to the first receiving antenna axis,
and/or
the phase centers of at least two receiving antenna elements may lie on a first receiving antenna axis, the phase center of at least one receiving antenna element may lie on a second receiving antenna axis, and the phase center of at least one receiving antenna element may lie on a third receiving antenna axis, wherein the first receiving antenna axis, the second receiving antenna axis and the third receiving antenna axis run parallel and wherein the at least one receiving antenna element on the second receiving antenna axis and the at least one receiving antenna element on the third receiving antenna axis lie on diagonally opposite sides of the at least two receiving antenna elements on the first receiving antenna axis. In this way, the performance of the radar system in a beamforming method, a MIMO method and a combination of beamforming method and MIMO method can be improved further.

The invention also achieves the object for the vehicle in that the vehicle has at least one radar system according to the invention and/or the vehicle has at least one radar system having means for carrying out a method according to the invention.

According to the invention, the vehicle has at least one radar system that can be used to monitor a monitoring region, in particular outside of the vehicle, for objects.

Advantageously, the vehicle may have at least one driver assistance system. A driver assistance system can be used to operate the vehicle autonomously or semiautonomously.

At least one radar system may advantageously be functionally connected to at least one driver assistance system. In this way, information about the monitoring region, in particular object information determined using the at least one radar system, can be used by the at least one driver assistance system in order to control autonomous or semiautonomous operation of the vehicle.

In other respects, the features and advantages indicated in connection with the method according to the invention, the radar system according to the invention and the vehicle according to the invention and the respective advantageous configurations thereof apply in a mutually corresponding manner and vice versa. The individual features and advantages can naturally be combined with one another, in which case other advantageous effects that go beyond the sum of the individual effects may result.

### BRIEF DESCRIPTION OF THE DRAWINGS

Further advantages, features and details of the invention will become apparent from the description that follows, in which exemplary embodiments of the invention are explained in more detail with reference to the drawing. A person skilled in the art will expediently also consider individually the features that have been disclosed in combination in the drawing, the description and the claims and will combine them to form meaningful further combinations. In the drawing, schematically,

FIG. 1 shows a plan view of a vehicle having a driver assistance system and 3 radar systems in a driving situation;

FIG. 2 shows a side view of the vehicle from FIG. 1;

FIG. 3 shows a detailed plan view of the vehicle from FIG. 1 in the region of the radar systems;

FIG. 4 shows a functional representation of one of the radar systems of the vehicle from FIG. 1;

FIG. 5 shows an arrangement of phase centers of an antenna arrangement having transmitting antenna elements and receiving antenna elements in accordance with a first exemplary embodiment of one of the radar systems of the vehicle from FIG. 1 during operation in a short-range measurement mode, phase centers of the transmitting antenna elements being shown alongside the phase centers of the receiving antenna elements;

FIG. 6 shows the arrangement of the phase centers of the antenna arrangement from FIG. 5 and the arrangement of the virtual phase centers of a corresponding virtual antenna array;

FIG. 7 shows a two-dimensional antenna radiation pattern for the virtual antenna array from FIG. 6;

FIG. 8 shows a horizontal pattern corresponding to the antenna radiation pattern from FIG. 7;

FIG. 9 shows a vertical pattern corresponding to the antenna radiation pattern from FIG. 7;

FIG. 10 shows the arrangement of the phase centers of the antenna arrangement in accordance with the first exemplary embodiment from FIG. 5 during operation in a long-range measurement mode;

FIG. 11 shows the arrangement of the phase centers of the antenna arrangement from FIG. 10 and the arrangement of the virtual phase centers of a corresponding virtual antenna array;

FIG. 12 shows a two-dimensional antenna radiation pattern for the virtual antenna array from FIG. 11;

FIG. 13 shows a horizontal pattern corresponding to the antenna radiation pattern from FIG. 12;

FIG. 14 shows a vertical pattern corresponding to the antenna radiation pattern from FIG. 12;

FIG. 15 shows an arrangement of phase centers of an antenna arrangement having transmitting antenna elements and receiving antenna elements in accordance with a second exemplary embodiment of one of the radar systems of the vehicle from FIG. 1 during operation in a short-range measurement mode, phase centers of the transmitting antenna elements being shown alongside the phase centers of the receiving antenna elements;

FIG. 16 shows the arrangement of the phase centers of the antenna arrangement from FIG. 15 and the arrangement of the virtual phase centers of a corresponding virtual antenna array;

FIG. 17 shows a two-dimensional antenna radiation pattern for the virtual antenna array from FIG. 16;

FIG. 18 shows a horizontal pattern corresponding to the antenna radiation pattern from FIG. 17;

FIG. 19 shows a vertical pattern corresponding to the antenna radiation pattern from FIG. 17;

FIG. 20 shows the arrangement of the phase centers of the antenna arrangement in accordance with the first exemplary embodiment from FIG. 15 during operation in a long-range measurement mode;

FIG. 21 shows the arrangement of the phase centers of the antenna arrangement from FIG. 20 and the arrangement of the virtual phase centers of a corresponding virtual antenna array;

FIG. 22 shows a two-dimensional antenna radiation pattern for the virtual antenna array from FIG. 21;

FIG. 23 shows a horizontal pattern corresponding to the antenna radiation pattern from FIG. 22;

FIG. 24 shows a vertical pattern corresponding to the antenna radiation pattern from FIG. 22.

In the figures, identical components are provided with identical reference signs.

### EMBODIMENT(S) OF THE INVENTION

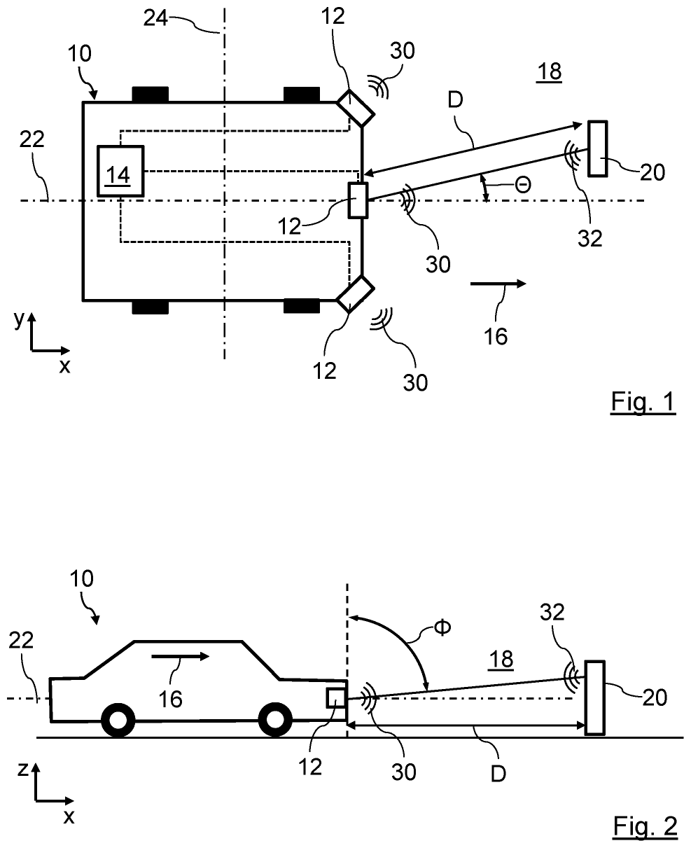

FIG. 1 shows a plan view of a vehicle 10 in the form of an automobile in a driving situation. FIG. 2 shows the vehicle 10 in a side view.

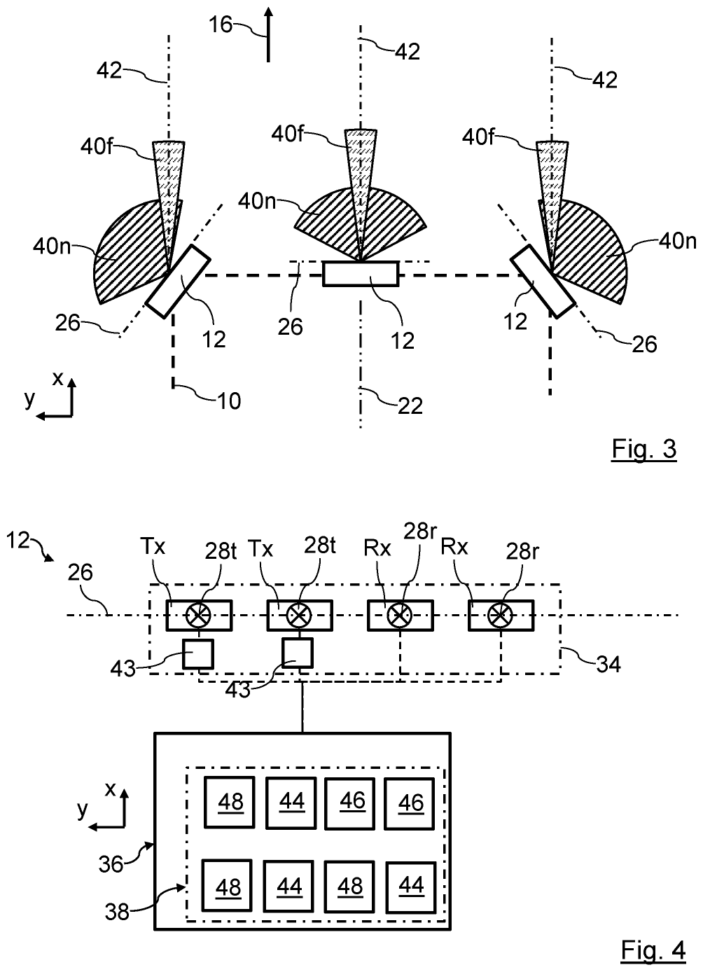

The vehicle 10 comprises, by way of example, three radar systems 12 and a driver assistance system 14. The radar systems 12 are arranged, by way of example, on the front side of the vehicle 10 in the direction of travel 16. The radar systems 12 can be used to monitor a monitoring region 18 in front and at an angle in front of the vehicle 10 for objects 20. FIG. 3 shows a detailed plan view of the three radar systems 12, outlines of the front part of the vehicle 10 being indicated by dashes.

In FIGS. 1 and 2, an object 20 that can be detected using the radar system 12 is arranged, by way of example, in front of the vehicle 10.

The radar systems 12 can be used to determine object information, for example distances D, directions, for example azimuth Θ and elevation angles Φ, and speeds of detected objects 20 relative to the vehicle 10.

The radar systems 12 are each functionally connected to the driver assistance system 14. Object information determined using the radar systems 12 can thus be transmitted to the driver assistance system 14. The driver assistance system 14 can be used to operate the vehicle 10 autonomously or at least semiautonomously.

In addition or as an alternative to the radar systems 12 shown by way of example, radar systems may also be arranged at different locations on the vehicle 10 and with a different alignment. For example, radar systems that are used to monitor a monitoring region behind or at an angle behind the vehicle 10 in the direction of travel 16 for objects 20 may also be arranged on the rear of the vehicle 10. Furthermore, there may also be provision for radar systems that, as side radar systems, can monitor appropriate monitoring regions to the side of the vehicle 10.

For the sake of simpler orientation, the applicable coordinates of a Cartesian xyz coordinate system are indicated in FIGS. 1 to 6, 10, 11, 15, 16, 20 and 21. By way of example, the x axis of the xyz coordinate system runs parallel to the vehicle longitudinal axis 22 of the vehicle 10. The y axis runs parallel to a vehicle transverse axis 24 of the vehicle 10 and the z axis runs spatially upward at right angles to the xy plane.

By way of example, one of the radar systems 12 is arranged in the center of the front fender and is used as a front radar system. The other two radar systems 12 are arranged on opposite sides of the front radar system 12 in a respective front corner region of the vehicle 10. The two outer radar systems 12 are used as corner radar systems.

An antenna plane 26 of the front radar system 12 runs at right angles to the vehicle longitudinal axis 22.

The respective antenna plane 26 of the radar systems 12 are virtual planes in which phase centers 28 of antenna elements of the respective radar system 12, specifically phase centers 28t of transmitting antenna elements Tx and phase centers 28r of receiving antenna elements Rx, are located. In the exemplary embodiment shown, the antenna planes 26 of all three radar systems 12 run at right angles to the xy plane, that is to say spatially vertically in the normal operating situation of the vehicle 10.

The right-hand corner radar system 12 as viewed in the direction of travel 16 is pivoted approximately 45° to the right, such that the antenna plane 26 thereof runs at an angle of approximately 45° with respect to the vehicle longitudinal axis 22. The left-hand radar system 12 as viewed in the direction of travel 16 is accordingly inclined −45° to the left, such that the antenna plane 26 thereof is accordingly inclined −45° to the left with respect to the vehicle longitudinal axis 22.

The radar systems 12 can be used to transmit radar signals 30 into the monitoring region 18. Radar signals 32 reflected from objects 20 in the direction of the radar systems 12 can be received by the radar systems 12 as echo signals 32. The corresponding object information, specifically the distance D, the azimuth Q, the elevation angle @ and the speed of the detected object 20 relative to the vehicle 10, can be determined from the echo signals 32.

The radar systems 12 are of identical design and operate in an identical manner. The design of the radar systems 12 is explained in more detail below by way of example on the basis of the front radar system 12 with reference to FIG. 4.

The radar system 12 comprises an antenna arrangement 34 having the transmitting antenna elements Tx and the receiving antenna elements Rx and a control and detection device 36. The control and detection device 36 can be used to actuate the transmitting antenna elements Tx to emit radar signals 30. Furthermore, the control and detection device 36 can be used to detect and evaluate the echo signals 32 received by the receiving antenna elements Rx. The control and detection device 36 can be used to determine the corresponding object information from said echo signals and to transmit said information to the driver assistance system 14.

The antenna arrangement 34 comprises a plurality of transmitting antenna elements Tx, only two of which are shown by way of example in FIG. 4, and a plurality of receiving antenna elements Rx, only two of which are also shown by way of example. The radar system 12 can be operated both using a MIMO (multiple-in-multiple-out) method and using a beamforming method.

In the MIMO method, the transmitting antenna elements Tx are actuated separately using transmission control signals by the control and detection device 36. Appropriate transmission control signals are used to render the radar signals 30 distinguishable, for example by way of encoding. It is thus possible for signal paths of the radar signals 30 and the corresponding echo signals 32 to be assigned to the respective transmitting antenna elements Tx at the receiver end.

In the beamforming methods, multiple transmitting antennas Tx are actuated together using coherent transmission control signals with appropriate phase shifts, which may also be zero. The individual radar signals emitted by each of the transmitting antennas Tx can thus interfere to form an overall radar signal 30. Applicable phase shifts allow the direction of a main beam axis 42 for the radar signal 30 to be changed. A phase shifter 43 is assigned to each transmitting antenna Tx in order to produce the phase shifts.

The control and detection device 36 comprises an adjustment means 38 that can be used to adjust an intended use mode and a measurement mode of the radar system 12.

The intended use mode is adjusted on the basis of the intended use of the corresponding radar system 12. In the case of the vehicle 10 described, for example three intended uses are shown for the radar system, specifically the intended use as a front radar system 12, as a right-hand corner radar system 12 or as a left-hand corner radar system 12.

Measurement modes are the modes in which the radar system 12 carries out radar measurements. Two measurement modes are described below by way of example, specifically a long-range measurement mode and a short-range measurement mode.

In the long-range measurement mode, the radar system 12 is operated using a combination of the MIMO method and the beamforming method. It is possible in the long-range measurement mode to detect objects 20 at distances of up to approximately 200 m in a long-range field of view 40f of the radar system 12, which is indicated in FIG. 3, and to ascertain the direction of said objects relative to the radar system 12 and the vehicle 10.

In the short-range measurement mode, the radar system 12 is operated using the MIMO method. It is possible in the short-range measurement mode to detect objects 20 in a short-range field of view 40n, for example at a distance of up to 100 m. The short-range field of view 40n has a beam angle that is significantly larger than the beam angle of the long-range field of view 40f.

In order to be able to identify objects 20 in front of the vehicle in the direction of travel 16 at an early stage, a basic main beam axis 42 of the antenna arrangement 34 in the long-range measurement mode should be aligned approximately parallel to the direction of travel 16, for example approximately parallel to the vehicle longitudinal axis 22, irrespective of the intended use of the radar system 12 as a front radar system 12 or a corner radar system 12. The basic main beam axis 42 defines the alignment of the long-range field of view 40f and the main propagation direction of the transmitted radar signals 30 in the basic setting of the radar system 12 for the applicable intended use.

During radar measurements, it is also optionally possible to change, for example pivot, the propagation direction of the radar signals 30 in the long-range measurement mode with respect to the basic main beam axis 42.

The accommodation of the alignment of the basic main beam axis 42 on the basis of the intended use of the radar system 12 as a front radar system or a corner radar system is stipulated using the adjustment means 38 over the intended use mode.

The adjustment means 38 comprises, by way of example, three basic control schemes 44, two measurement control schemes 46 and, by way of example, three intended use variables 48.

The measurement control schemes 46 each contain the specifications according to which transmission control signals are transmitted to the transmitting antenna elements Tx in accordance with the desired measurement mode. By way of example, there is provision for one measurement control scheme 46 for the long-range measurement mode and one measurement control scheme 46 for the short-range measurement mode.

The basic control schemes 44 each contain the specifications according to which the applicable transmission control signals are transmitted to the transmitting antenna elements Tx in the long-range measurement mode in order to align the basic main beam axis 42.

The intended use variables 48 each characterize an intended use of the radar system 12. By way of example, the use variables 48 may be stored in a memory of the control and detection device 14. By way of example, each of the intended use variables 48 is a phase shift. In the beamforming method, in order to implement the long-range measurement mode, the transmitting antenna elements Tx can be actuated together using coherent transmitting signals, between which the applicable phase shift specified as the intended use variable 48 is adjusted. The applicable phase shift allows the basic main beam axis 42 to be aligned relative to the antenna plane 26 of the radar system 12 in order to accommodate it to the intended use of said radar system.

By way of example, there may be provision in the adjustment means 38 for a basic control scheme 44 and an intended use variable 48 for the use of the radar system 12 as a front radar system, a basic control scheme 44 and an intended use variable 48 for the use as a left-hand corner radar system and a basic control scheme 44 and an intended use variable 48 for the use as a right-hand corner radar system.

The intended use mode can be adjusted by implementing the basic control scheme 44 with the applicable intended use variable 48. By way of example, the basic control scheme 44 for the right-hand corner radar system 12 may include the actuation of the transmitting antenna elements Tx using coherent transmission control signals that are shifted by the specified phase shift so that the basic main beam axis 42 of the resulting radar signal 30 is pivoted −45° with respect to the antenna plane 26. The 45° pivoted alignment of the corner radar system 12 can thus be corrected in order to align the basic main beam axis 42 parallel to the direction of travel 16 or the vehicle longitudinal axis 22.

Depending on the arrangement of the transmitting antenna elements Tx and the intended use of the radar system 12, the phase shift may also be zero.

The applicable intended use variable 48 can be adjusted during installation of the radar system 12 on the vehicle 10 or before. More or fewer than the three intended use variables 48 can also be stored in the radar system 12. For example, there may thus be provision for intended use variables for uses on different vehicles and/or at different locations and/or with different orientations on vehicles. The radar system 12 can thus be used and appropriately accommodated universally for different vehicles and different uses on or in vehicles.

The adjustment means 38 is implemented in the control and detection device 36 for example using software. It is thus not necessary to change the hardware of the radar system 12 in order to accommodate the radar system 12 to different intended uses.

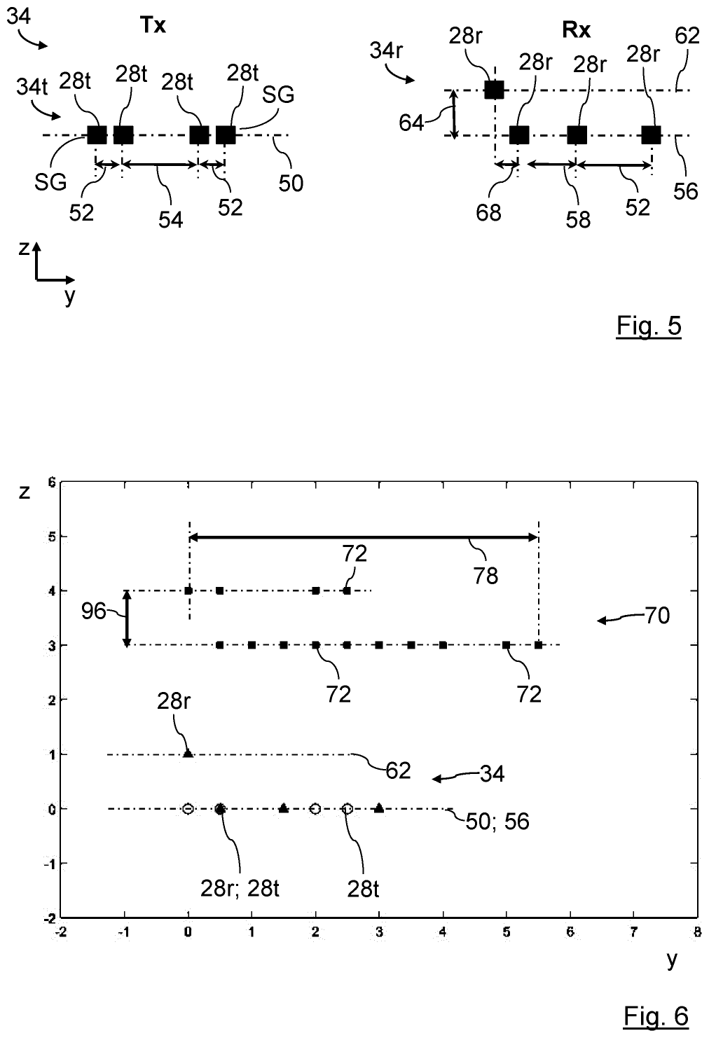

The operation of the radar system 12 having an antenna arrangement 34 in accordance with a first exemplary embodiment is explained in more detail below in the short-range measurement mode with reference to FIGS. 5 to 9 and in the long-range measurement mode with reference to FIGS. 10 to 14.

FIG. 5 and the bottom of FIG. 6 show the phase centers 28t of the transmitting antenna elements Tx and the phase centers 28r of the receiving antenna elements Rx of the antenna arrangement 34. For the sake of better clarity, FIG. 5 shows the transmitting antenna arrangement 34t on the left-hand side separately from the receiving antenna arrangement 34r on the right. The transmitting antenna arrangement 34t and the receiving antenna arrangement 34r may also be arranged differently from one another. The transmitting antenna arrangement 34t and the receiving antenna arrangement 34r may also overlap, as shown at the bottom of FIG. 6. For the purpose of better distinction, the phase centers 28t of the transmitting antenna elements Tx are depicted using circles here and the phase centers 28r of the receiving antenna elements Rx are depicted using black triangles.

The transmitting antenna arrangement 24s comprises four transmitting antenna elements Tx. The phase centers 28t are arranged on an imaginary transmitter antenna axis 50. The transmitter antenna axis 50 runs in the antenna plane 26 and, by way of example, horizontally, parallel to the xy plane.

The four phase centers 28t are arranged in two transmitting antenna groups SG. A distance 52 between the phase centers 28t of the same transmitting antenna group SG corresponds to approximately half the wavelength λ of the radar signals 30 emitted by the transmitting antenna elements Tx. A distance 54 between the phase centers 28t of the two transmitting antenna elements Tx on the sides facing the two transmitting antenna groups SG is approximately 3/2 of the wavelength λ.

The receiving antenna arrangement 34r comprises a total of four receiving antenna elements Rx. Three of the phase centers 28r are arranged on a first receiving antenna axis 56. In the exemplary embodiment shown, the first receiving antenna axis 56 runs coaxially with the transmitter antenna axis 50 of the transmitting antenna arrangement 34t in the antenna plane 26.

The three transmitting antenna elements Tx on the first receiving antenna axis 56 form a group of three.

A distance 58 between the left-hand phase center 28r and the middle phase center 28r of the group of three on the first receiving antenna axis 56 in FIGS. 5 and 6 corresponds to approximately the wavelength λ of the radar signals 30. A distance 60 between the phase center 28r of the middle receiving antenna element Rx and the phase center 28r of the right-hand receiving antenna element Rx corresponds to approximately 3/2 of the wavelength λ of the radar signals 30.

The phase center 28r of the fourth receiving antenna element Rx is arranged on a second receiving antenna axis 62. The second receiving antenna axis 62 runs parallel to the first receiving antenna axis 56 in the antenna plane 26. A distance 64 between the first receiving antenna axis 56 and the second receiving antenna axis 62 corresponds to the wavelength λ of the radar signals 30.

A perpendicular 66 through the phase center 28r of the fourth receiving antenna element Rx to the first receiving antenna axis 56 is located outside of the group of three phase centers 28r of the receiving antenna elements Rx on the first receiving antenna axis 56. In FIGS. 5 and 6, the phase center 28r of the receiving antenna element Rx on the second receiving antenna axis 62 is offset to the left with respect to the group of three phase centers 28r on the first receiving antenna axis 56.

A distance 68 between the perpendicular 66 to the first receiving antenna axis 56 through the phase center 28r on the second receiving antenna axis 62 and the phase center 28r of the left-hand receiving antenna element Rx in FIG. 5 on the first receiving antenna axis 56 corresponds to half the wavelength λ of the radar signals 30.

In the short-range measurement mode, the radar system 12 is operated according to the MIMO method. This involves the transmitting antenna elements Tx being operated separately, for example using transmission control signals that are encoded with respect to one another, and so the transmitting antenna elements Tx emit distinguishable radar signals 30.

Geometric folding of the geometric positions of the phase centers 28t of the transmitting antenna elements Tx and phase centers 28r of the receiving antenna elements Rx is used to generate a virtual antenna array 70 that is shown at the top of FIG. 6. The virtual phase centers 72 of the virtual antenna elements of the virtual antenna array 70 are indicated as black squares in FIG. 6.

In accordance with the first exemplary embodiment, during operation of the radar system 12 in the short-range measurement mode, a total of 14 virtual antenna elements having corresponding virtual phase centers 72 are generated for the antenna arrangement 34. The virtual phase centers 72 are arranged on a first virtual antenna axis 74 and a second virtual antenna axis 76. The virtual antenna axes 74 and 76 run in the antenna plane 26 parallel to the transmitter antenna axes 50, 56 and 62. The distribution of the virtual phase centers 72 along each of the virtual antenna axes 74 and 76 allows the azimuth Θ to be determined. The distribution of the virtual phase centers 72 over the two spaced-apart virtual antenna axes 74 and 76, that is to say over two elevation planes, makes it possible to ascertain the elevation angle Φ.

A distance 78 between the virtual phase center 72, located furthest on the left in FIG. 6 and on the second virtual antenna axis 74, and a virtual phase center 72, located furthest on the right and on the first virtual antenna axis 74, defines the aperture of the antenna arrangement 34.

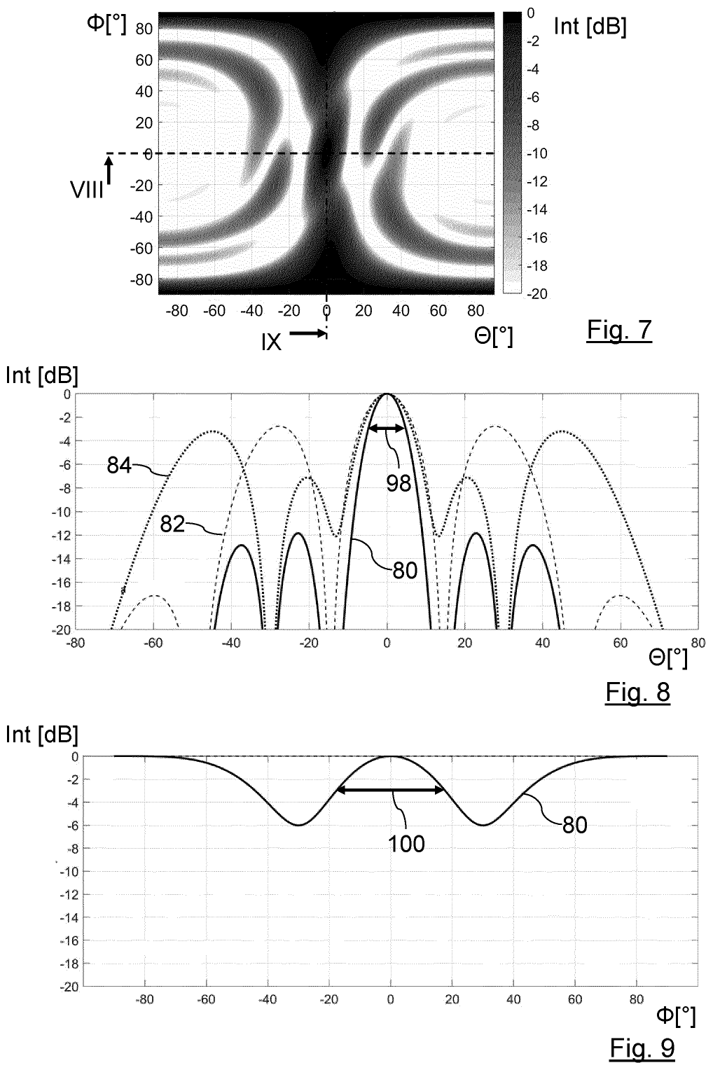

FIG. 7 shows, by way of example, a two-dimensional antenna radiation pattern for the virtual antenna array 70 in the short-range measurement mode using the MIMO method in grayscale in the two direction dimensions elevation angle Φ and azimuth Θ. The assignment of the grayscale to standardized intensities is shown on an intensity scale on the right-hand side in dB. The azimuth Θ in degrees is shown in the direction of the abscissa. The elevation angle Φ, also in degrees, is shown on the ordinate.

FIG. 8 shows a horizontal pattern corresponding to the two-dimensional antenna radiation pattern from FIG. 7 as a function of the azimuth Θ for the elevation angle Θ=0°, along the sectional line VIII from FIG. 7. The standardized intensity curve 80 for the virtual array 70 is shown using solid lines 80 in FIG. 8. Purely for comparison, the standardized intensity curve 82 for the transmitting antenna arrangement 34t is shown using dashed lines. The standardized intensity curve 84 for the receiving antenna arrangement 34r is shown using dotted lines.

FIG. 9 shows a vertical pattern corresponding to the two-dimensional antenna radiation pattern from FIG. 7 as a function of the elevation angle Φ for the azimuth Θ=0°, along the reproduced sectional line IX from FIG. 7.

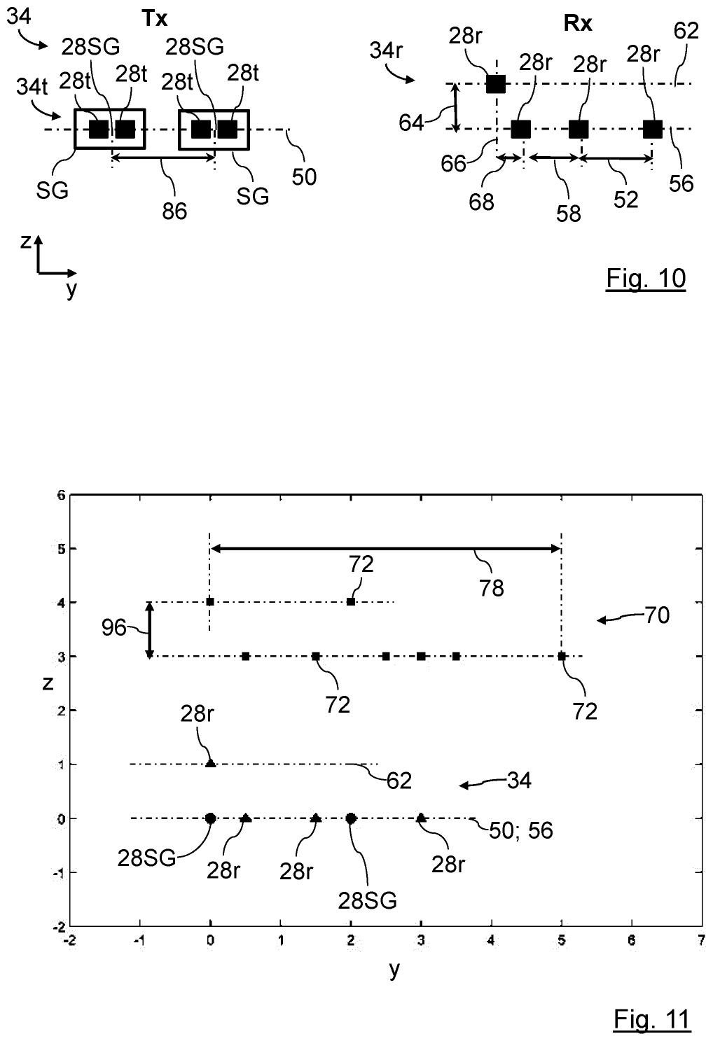

The operation of the radar system 12 having the antenna arrangement 34 in accordance with the first exemplary embodiment in the long-range measurement mode is explained in more detail below in consideration of FIGS. 10 to 14. The antenna arrangement 34 is shown in FIG. 10 or at the bottom of FIG. 11. The transmitting antenna arrangement 34t and the receiving antenna arrangement 34r are shown alongside one another in FIG. 10 analogously to the depiction in FIG. 5. FIG. 11 shows the antenna arrangement 34 analogously to the depiction in FIG. 6.

In the long-range measurement mode, a combination of the MIMO method explained in connection with FIGS. 5 to 9 and the beamforming method is carried out, this being referred to as the “MIMO/beamforming method” below. This involves the transmitting antenna elements Tx of the same transmitting antenna group SG being actuated using the same coherent transmission control signals with a phase shift specified by the intended use variable 48. The basic main beam axis 42 is adjusted according to the intended use by specifying the appropriate phase shift.

The two transmitting antenna groups SG are actuated using different transmission control signals, for example which are encoded with respect to one another, and so the echo signals 32 of the radar signals 30 transmitted by the two transmitting antenna groups SG can be assigned to the respective transmitting antenna group SG by the receiving antenna elements Rx.

A group phase center 28SG located geometrically between the individual phase centers 28t of the transmitting antenna elements Tx of the respective transmitting antenna group SG is implemented for each transmitting antenna group SG. A distance 86 between the group phase centers 28SG is approximately twice the wavelength λ of the transmitted radar signals 30.

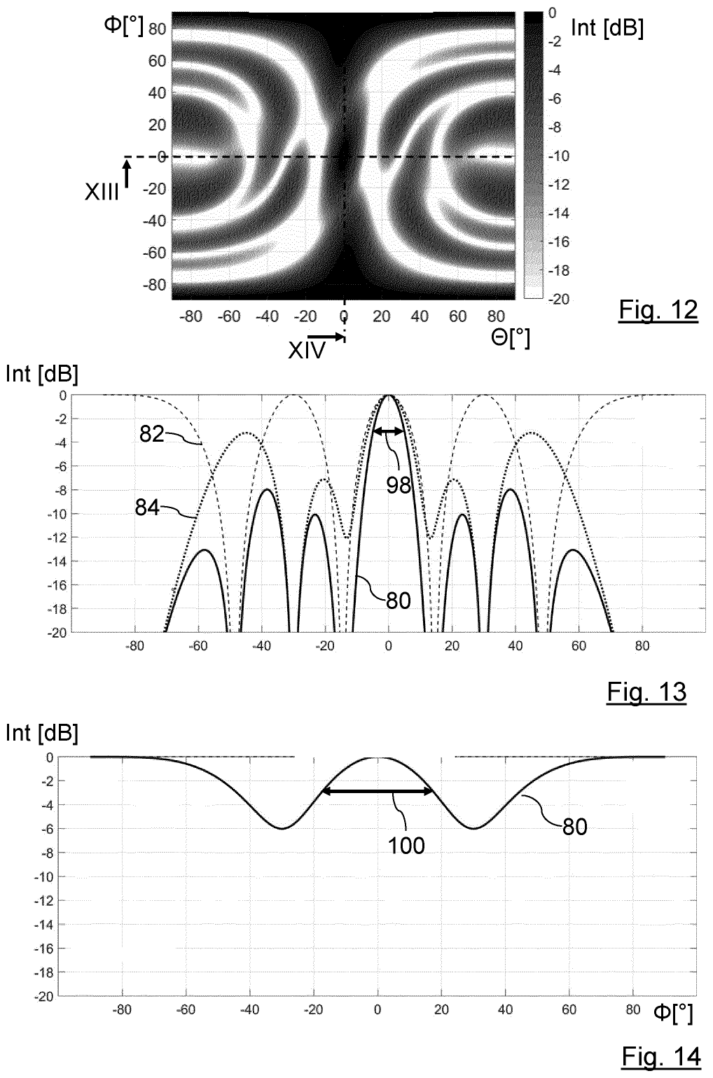

The geometric folding of the positions of the group phase centers 28SG of the transmitting groups SG and the receiving phase centers 28r of the receiving antenna elements Rx in the MIMO/beamforming method is used to implement a virtual array 70, the virtual phase centers 72 of which are shown at the top of FIG. 11. The total number of virtual array elements with virtual phase centers 72 shown in FIG. 11 amounts to a total of eight, and is thus lower than the total number of virtual array elements in the MIMO method explained in connection with FIGS. 5 to 9. This increases the sidelobe levels. This is clear from the antenna radiation patterns in FIGS. 12 and 13. However, a greater range is also achieved, which is required in the long-range measurement mode.

FIG. 12 shows, by way of example, a two-dimensional antenna radiation pattern for the virtual antenna array 70 in the long-range measurement mode using the MIMO/beamforming method in grayscale in the two direction dimensions elevation angle Φ and azimuth Θ. The assignment of the grayscale to standardized intensities is shown on an intensity scale on the right-hand side in dB. The azimuth Θ in degrees is shown in the direction of the abscissa. The elevation angle Φ, also in degrees, is shown on the ordinate.

FIG. 13 shows a horizontal pattern corresponding to the two-dimensional antenna radiation pattern from FIG. 12 as a function of the azimuth Θ for the elevation angle Φ=0°, along the reproduced sectional line XIII in FIG. 12. The standardized intensity curve 80 for the virtual array 70 is shown using solid lines 80 in FIG. 13. Purely for comparison, the standardized intensity curve 82 for the transmitting antenna arrangement 34t is shown using dashed lines. The standardized intensity curve 84 for the receiving antenna arrangement 34r is shown using dotted lines.

FIG. 14 shows a vertical pattern corresponding to the two-dimensional antenna radiation pattern from FIG. 12 as a function of the elevation angle Φ for the azimuth Θ=0°, along the reproduced sectional line XIV in FIG. 12.

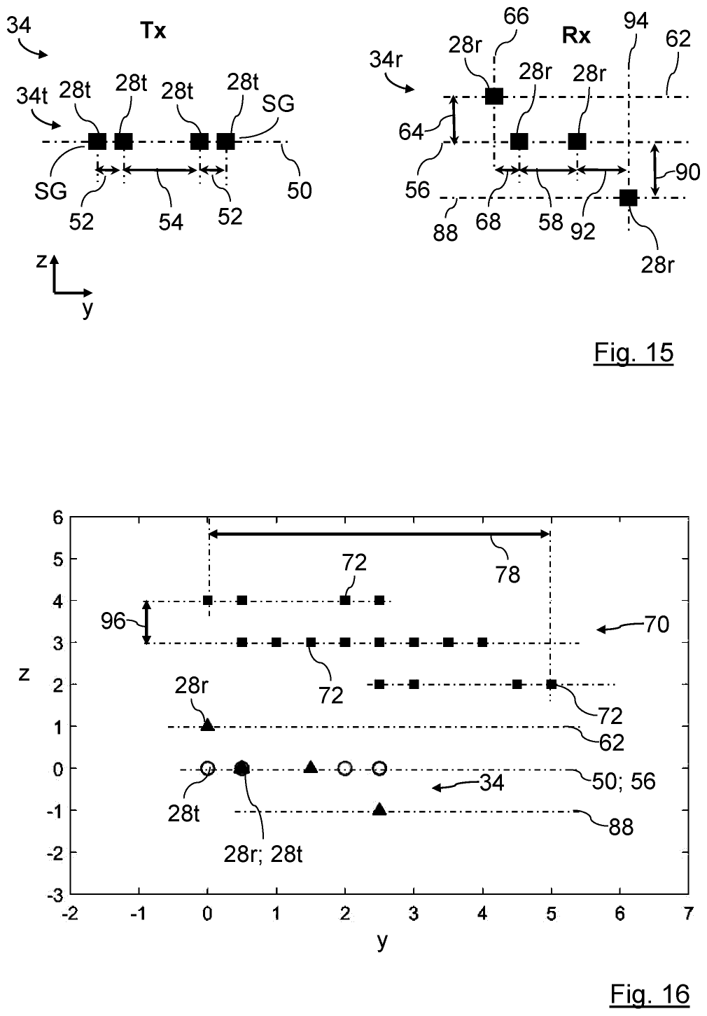

The operation of the radar system 12 having an antenna arrangement 34 in accordance with a second exemplary embodiment is explained in more detail below with reference to FIGS. 15 to 19 in the short-range measurement mode using the MIMO method and with reference to FIGS. 20 to 24 in the long-range measurement mode using the MIMO/beamforming method. Those elements which are similar to those of the first exemplary embodiment from FIGS. 6 to 14 are provided with the same reference signs.

The antenna arrangement 34 shown in FIG. 15 and at the bottom of FIG. 16 in accordance with the second exemplary embodiment differs from the antenna arrangement 34 in accordance with the first exemplary embodiment from FIGS. 5 and 6 in that the phase center 28r of the right-hand receiving antenna element Rx in FIG. 15 is arranged on a third receiving antenna axis 88 instead of on the first receiving antenna axis 56.

The third receiving antenna axis 88 runs parallel to the first receiving antenna axis 56 on the opposite side of the first receiving antenna axis 56 from the second receiving antenna axis 62. The third receiving antenna axis 88 is also located in the antenna plane 26.

A distance 90 between the first receiving antenna axis 56 and the third receiving antenna axis 90 corresponds to the distance 64 between the first receiving antenna axis 56 and the second receiving antenna axis 62. The distance 90 corresponds to approximately the wavelength λ of the emitted radar signals 30.

A distance 92 between the perpendicular 94 to the first antenna axis 56 through the phase center 28r of the receiving antenna element Rx on the third receiving antenna axis 88 and the phase center 28r of the adjacent receiving antenna element Rx, specifically the right-hand phase center 28r on the first receiving antenna axis 56, corresponds to approximately the wavelength λ of the emitted radar signals 30.

The perpendicular 94 is located outside of the region of the phase centers 28r of the two inner receiving antenna elements Rx on the first receiving antenna axis 56. The perpendicular 94 through the phase center 28r on the third receiving antenna axis 88 is located on the opposite side of the region containing the two middle receiving antenna centers 28r on the first receiving antenna axis 56 from the perpendicular 66 through the first phase center 28r on the second receiving antenna axis 94.

FIG. 16 shows the phase centers 28 of the antenna arrangement 34 in accordance with the second exemplary embodiment at the bottom, and the corresponding virtual array 70 at the top, during operation of the radar system 12 in the short-range measurement mode using the MIMO method.

The top of FIG. 16 shows the virtual phase centers 72 of the virtual array 70 that is part of the antenna arrangement 34 in accordance with the second exemplary embodiment in the short-range measurement mode.

An extent 96 of the virtual array 70 in elevation, which runs parallel to the z axis, is greater than the corresponding extent 96 for the antenna arrangement 34 in accordance with the first exemplary embodiment from FIGS. 5 to 14. In addition to measuring the elevation angle Φ, the antenna arrangement 34 in accordance with the second exemplary embodiment can be used to achieve a resolution in the elevation direction with the ability to separate two detected objects.

The middle row of the virtual array 70 is fully occupied in the direction of the azimuth Θ, for example in the direction of the y axis, which reduces the sidelobe levels.

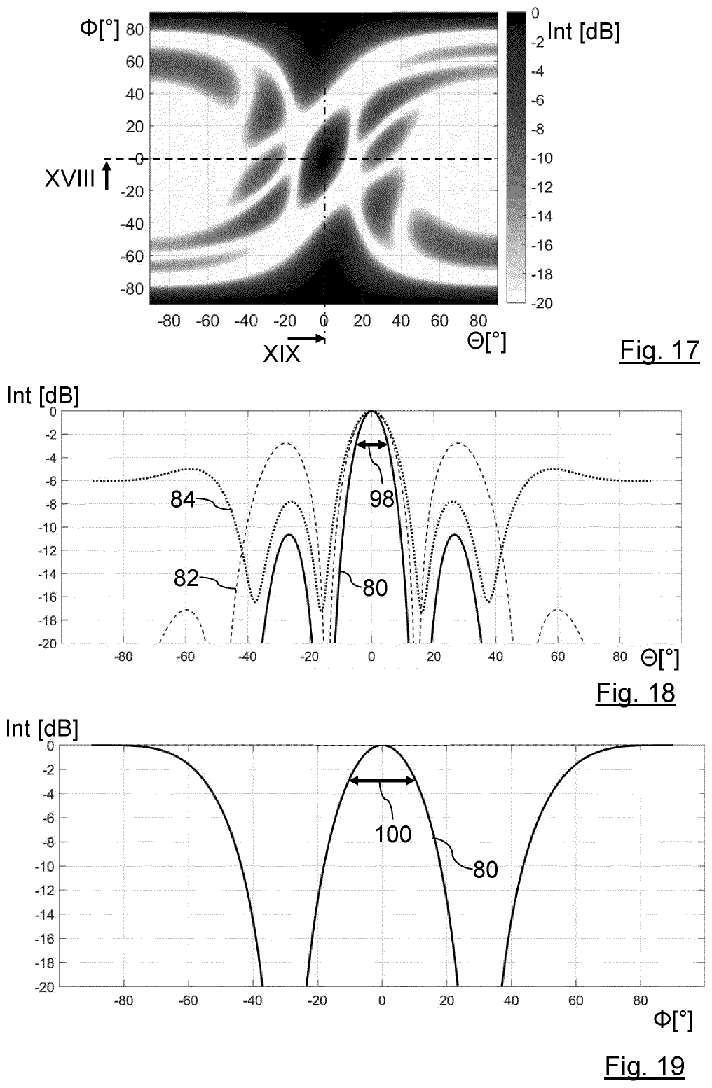

FIG. 17 shows, by way of example, a two-dimensional antenna radiation pattern for the virtual antenna array 70 in accordance with the second exemplary embodiment in the short-range measurement mode using the MIMO method in grayscale in the two direction dimensions elevation angle Φ and azimuth Θ. The assignment of the grayscale to standardized intensities is shown on an intensity scale on the right-hand side in dB. The azimuth Θ in degrees is shown in the direction of the abscissa. The elevation angle Φ, also in degrees, is shown on the ordinate.

FIG. 18 shows a horizontal pattern corresponding to the two-dimensional antenna radiation pattern from FIG. 17 as a function of the azimuth Θ for the elevation angle Φ=0°, along the sectional line XVIII from FIG. 17. The standardized intensity curve 80 for the virtual array 70 is shown using solid lines 80 in FIG. 18. Purely for comparison, the standardized intensity curve 82 for the transmitting antenna arrangement 34t is shown using dashed lines. The standardized intensity curve 84 for the receiving antenna arrangement 34r is shown using dotted lines.

FIG. 19 shows a vertical pattern corresponding to the two-dimensional antenna radiation pattern from FIG. 17 as a function of the elevation angle Φ for the azimuth Θ=0°, along the sectional line XIX from FIG. 17.

The operation of the radar system 12 having the antenna arrangement 34 in accordance with the second exemplary embodiment in the long-range measurement mode using the MIMO/beamforming method is described below with reference to FIGS. 20 to 24.

In the long-range measurement mode, the transmitting antenna elements Tx are operated analogously to operation in the long-range measurement mode with the antenna arrangement 34 in accordance with the first exemplary embodiment from FIGS. 11 to 14.

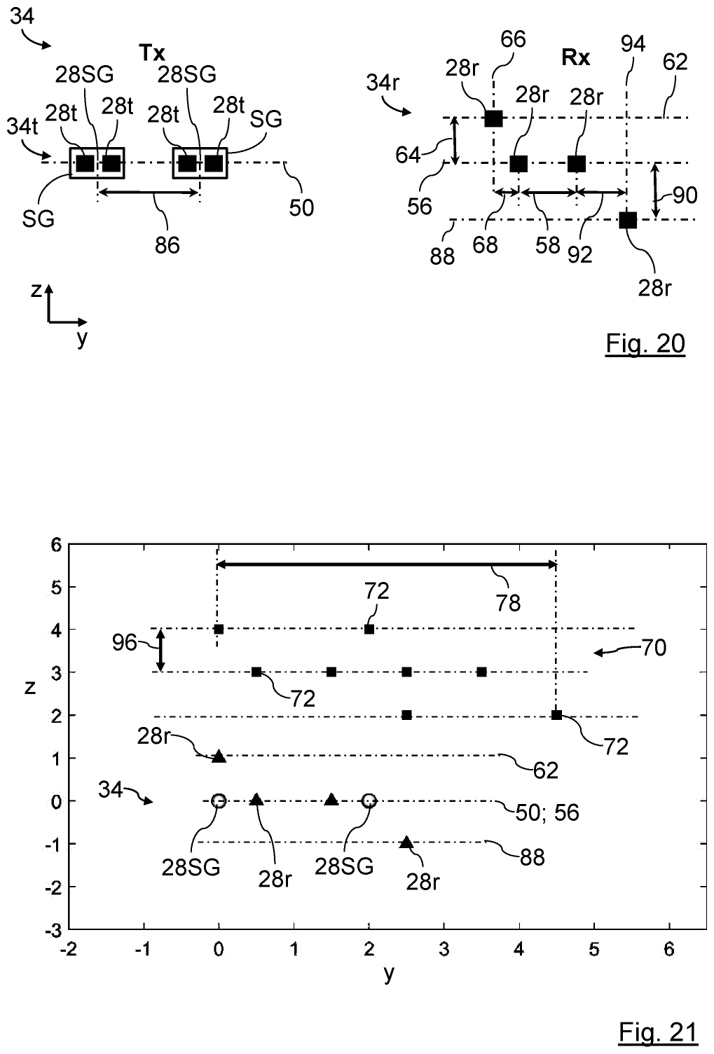

The virtual phase centers 72 of the resultant virtual antenna array 70 are shown at the top of FIG. 21. As with the operation of the radar system 12 having the antenna arrangement 34 in accordance with the second exemplary embodiment in the short-range measurement mode, shown in FIGS. 15 to 19, the virtual phase centers 72 are distributed over three elevation planes.

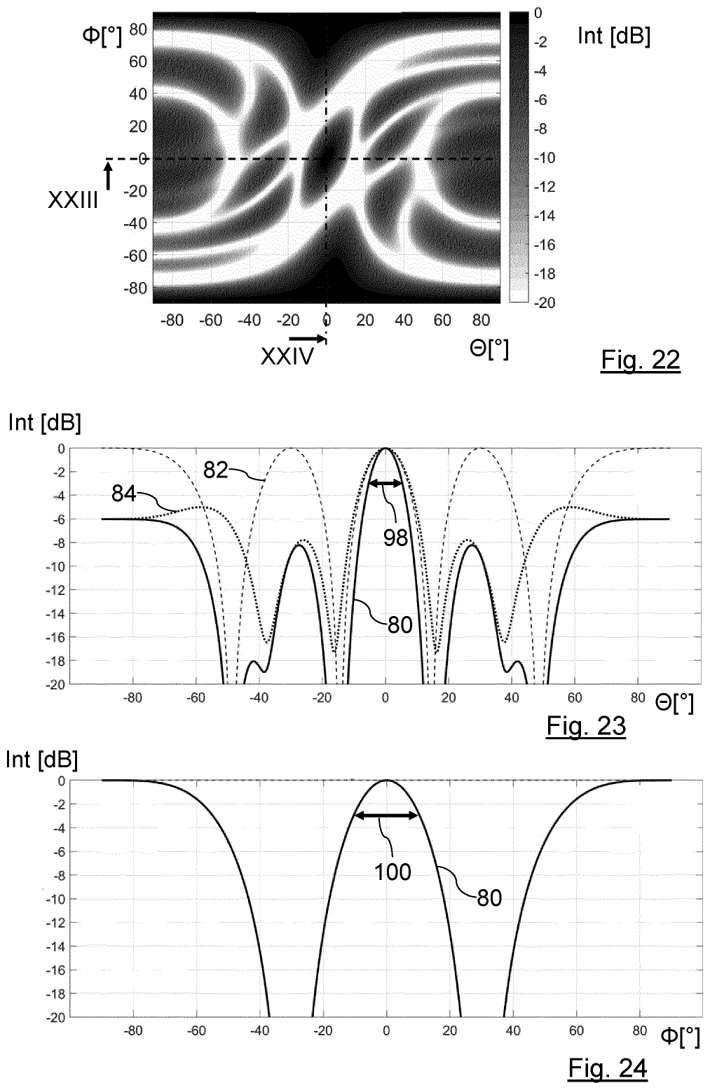

The actuation of the transmitting antenna elements Tx in groups reduces the total number of virtual antenna arrays 70 to 8. This increases the intensity of the sidelobe levels, as shown in FIGS. 22 to 24. The beamforming within the MIMO/beamforming method permits a greater range, given virtually unchanged angular resolution, compared with operation in the short-range measurement mode, however.

FIG. 22 shows, by way of example, a two-dimensional antenna radiation pattern for the virtual antenna array 70 in the long-range measurement mode using the MIMO/beamforming method in grayscale in the two direction dimensions elevation angle Φ and azimuth Θ. The assignment of the grayscale to standardized intensities is shown on an intensity scale on the right-hand side in dB. The azimuth Θ in degrees is shown in the direction of the abscissa. The elevation angle Φ, also in degrees, is shown on the ordinate.

FIG. 23 shows a horizontal pattern corresponding to the two-dimensional antenna radiation pattern from FIG. 22 as a function of the azimuth Θ for the elevation angle Φ=0°, along the sectional line XXIII from FIG. 22. The standardized intensity curve 80 for the virtual array 70 is shown using solid lines 80 in FIG. 23. Purely for comparison, the standardized intensity curve 82 for the transmitting antenna arrangement 34t is shown using dashed lines. The standardized intensity curve 84 for the receiving antenna arrangement 34r is shown using dotted lines.

FIG. 24 shows a vertical pattern corresponding to the two-dimensional antenna radiation pattern from FIG. 22 as a function of the elevation angle Φ for the azimuth Θ=0°, along the sectional line XXIV from FIG. 22.

As can be seen from FIGS. 18 and 23, a full width at half maximum 98 of the main lobe in the direction of the azimuth Θ at the 3 dB limit is 10.5° in the antenna arrangement 34 in accordance with the second exemplary embodiment. In the antenna arrangement 34 in accordance with the first exemplary embodiment, the corresponding full width at half maximum 98 in the direction of the azimuth Θ is only 9.5°, as can be seen from FIGS. 7 and 13.

In the antenna arrangement 34 in accordance with the second exemplary embodiment, the full width at half maximum 100 of the main lobe in the direction of the elevation angle Φ at the 3 dB limit is 21°, as can be seen from FIGS. 19 and 24. In the antenna arrangement 34 in accordance with the first exemplary embodiment, the corresponding full width at half maximum 100 in the direction of the elevation angle Φ at the 3 dB limit is 35.5°, as can be seen from FIGS. 9 and 14.

1. A method for operating a radar system for a vehicle, wherein the radar system is configured to carry out at least one radar measurement, the method comprising:
using at least one transmitting antenna element of at least one transmitting antenna arrangement of the radar system to transmit at least one radar signal; and
putting at least one receiving antenna element of at least one receiving antenna arrangement of the radar system on standby to receive any radar echo signals based on the at least one radar signal,
wherein the at least one transmitting antenna element is actuated according to at least one control scheme,
wherein a basic control scheme for the radar system, which is specified according to the intended use of the radar system on the vehicle, is adjusted for at least one measurement mode of the radar system at the latest at the beginning of the at least one radar measurement,
wherein the basic control scheme is used to accommodate a basic main beam axis of the at least one transmitting antenna arrangement to the intended use of the radar system, and
wherein the at least one radar measurement is carried out starting from the basic control scheme.

2. The method as claimed in claim 1,
wherein at least two transmitting antenna elements of at least one transmitting antenna arrangement are actuated using respective transmission control signals in order to emit respective mutually coherent individual radar signals that are superposed to form the at least one radar signal,
wherein, in the basic control scheme for the radar system, a basic phase shift, which may also be zero, between the respective transmission control signals is specified for the at least two transmitting antenna elements.

3. The method as claimed in claim 1,
wherein a a basic phase shift, between the respective transmission control signals is adjusted by means of at least one phase shifter, and/ or a phase shift that is linearly proportional to a distance between the at least two transmitting antenna elements is adjusted.

4. The method as claimed in claim 1,
wherein at least one basic control scheme is adjusted using at least one intended use variable that characterizes an intended use,
wherein the at least one intended use variable is specified in a control device for a control device of the radar system, at the latest when the radar system is mounted on the vehicle, and/ or
wherein at least one basic control scheme is adjusted in a control device for the control device of the radar system.

5. The method as claimed in claim 1,
wherein the basic control scheme is used to accommodate the basic main beam axis to the intended use in a long-range measurement mode of the radar system, and
wherein the radar system is operated in different range measurement modes, in particular a long-range measurement mode and a short-range measurement mode, in alternation or at at least partly overlapping times, and
wherein at least one of the transmitting antenna elements is actuated in multiple different range measurement modes in order to transmit radar signals, and/ or multiple receiving antenna elements of at least one receiving antenna arrangement are put on standby to receive echo signals.

6. The method as claimed in claim 1,
wherein the radar system is operated at least temporarily using a control scheme based on a beamforming method and/or at least temporarily using a control scheme based on a MIMO method, and
wherein the at least one transmitting antenna arrangement is actuated at least temporarily in at least two transmitting antenna groups, wherein the transmitting antenna elements within one transmitting antenna group are actuated together and the transmitting antenna groups are actuated separately.

7. The method as claimed in claim 1,
wherein at least one respective corresponding basic control scheme is specified for the use of the radar system as a front radar system, a corner radar system, a side radar system and/or a rear radar system, and
wherein the basic control scheme is used to align the basic main beam axis of the at least one transmitting antenna arrangement relative to a vehicle longitudinal axis or an antenna plane.

8. The method as claimed in claim 1,
wherein at least one radar measurement involves:
ascertaining at least one direction variable, which characterizes at least one direction of at least one object that reflects the at least one transmitted radar signal relative to the radar system in at least one dimension, and
ascertaining at least one distance variable, which characterizes at least one distance of at least one object that reflects the at least one transmitted radar signal relative to the radar system, and
ascertaining at least one speed variable, which characterizes at least one speed of at least one object that reflects the at least one transmitted radar signal relative to the radar system.

9. The method as claimed in claim 1,
wherein multiple transmitting antenna elements of an antenna arrangement are actuated in order to transmit radar signals, and
wherein multiple receiving antenna elements of the antenna arrangement are put on standby to receive echo signals,
wherein geometric folding of the geometric position of the transmitting antenna elements and the receiving antenna elements of the antenna arrangement are used to determine a corresponding virtual receiving antenna array.

10. A radar system for a vehicle comprising:
at least one transmitting antenna arrangement that has at least one transmitting antenna element for transmitting radar signals,
at least one receiving antenna arrangement that has at least one receiving antenna element for receiving radar echo signals, and
at least one control and detection device for actuating at least the transmitting antenna elements and for detecting radar echo signals received by the at least one receiving antenna element,
wherein the radar system has at least one adjustment means having at least one control scheme in order to adjust at least one main beam axis of the at least one transmitting antenna arrangement,
wherein the radar system comprises means for carrying out the method as claimed in claim 1.

11. A vehicle having at least one radar system,
wherein the vehicle has at least one radar system comprising means for carrying out the method as claimed in claim 1.
